(19) United States
(12) Patent Application Publication
(10) Pub. No.: US 2012/0156451 A1
(43) Pub. Date: Jun. 21, 2012

(54) INK COMPOSITION AND PRINTED ARTICLE

(75) Inventor: Masakazu Ohashi, Matsumoto-shi (JP)

(73) Assignee: SEIKO EPSON CORPORATION, Tokyo (JP)

(21) Appl. No.: 13/333,096

(22) Filed: Dec. 21, 2011

(30) Foreign Application Priority Data
Dec. 21, 2010 (JP) 2010-284267

(51) Int. Cl. B32B 33/00; B32B 3/00; C09D 11/12

(52) U.S. Cl. 428/207; 106/31.61; 106/31.62

(57) ABSTRACT

The ink composition contains a glitter pigment and wax. In the case where an aqueous solution containing the wax of 0.1 weight % is prepared, the wax serves to satisfy the following relationship: a transmittance of at least 50% and less than 100% with respect to light having a wavelength of 450 nm; a transmittance of at least 60% and less than 100% with respect to light having a wavelength of 550 nm; a transmittance of at least 70% and less than 100% with respect to light having a wavelength of 650 nm; or a transmittance of at least 70% and less than 100% with respect to light having a wavelength of 750 nm.

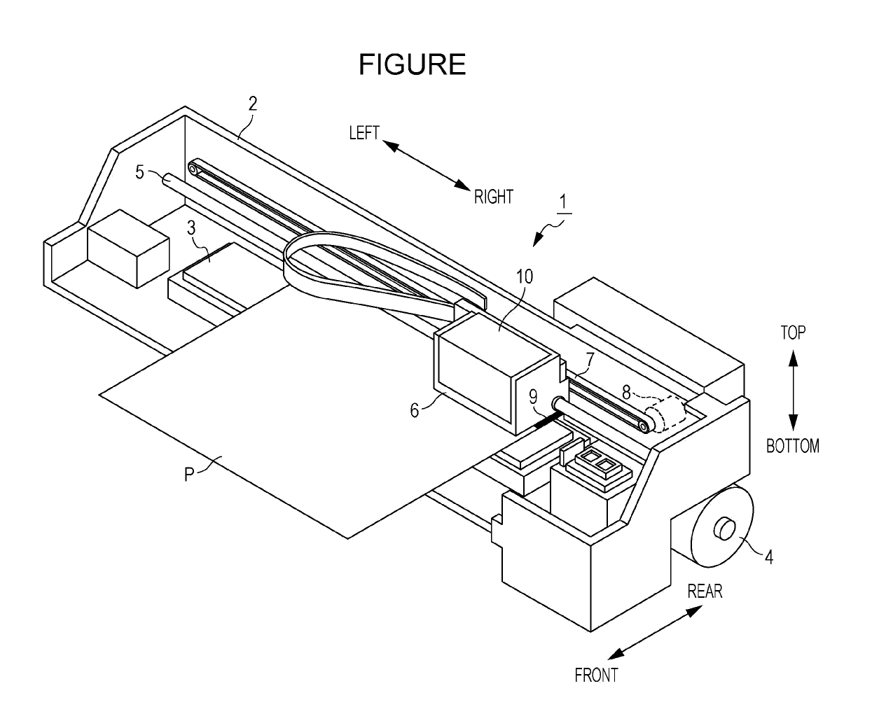

Priority is claimed under 35 U.S.C. §119 to Japanese Application No. 2010-284267 filed on Dec. 21 2010, is hereby incorporated by reference in its entirety.

### BACKGROUND

1. Technical Field

The present invention relates to an ink composition and a printed article which can be each suitably applied to ink jet printing.

2. Related Art

In ink jet printing, cyan, magenta, yellow, and black inks are typically used, thereby forming full-color images. In order to increase the quality of images to be formed, multiple ink colors are used (for example, six ink colors including light magenta and light cyan in addition to the above four ink colors).

Unfortunately, a problem arises, in which the use of the multiple ink colors fails in providing sufficient glossiness. In recent years, accordingly, an ink jet ink using metallic particles (glitter ink) has been proposed (see, JP-A-2007-297423, for example).

However, although use of the ink supposed in JP-A-2007-297423 enables relatively good glossiness to be provided, such an ink also causes disadvantages in which a printing surface is scratched with the result that a layer made of a material contained in the ink becomes bruised and is peeled. Such disadvantages result in the decreased gloss of formed images and the significant decrease of image quality. In the case of using color inks (pigment ink and dye ink) other than the metallic ink, such disadvantages are not generally generated, or decreased image quality is less prominent if any as compared with the case in which the metallic ink is used.

### SUMMARY

Study for embodiments of the invention has been made to overcome the above problems at least in part. An advantage of some aspects of the invention is that it provides an ink composition which can be used to form an image having excellent glossiness and excellent abrasion resistance (resistance to friction) and provides a printed article in which the image having excellent metallic luster and excellent abrasion resistance is formed.

According to a first aspect of the invention, an ink composition is provided, which contains a glitter pigment and wax. In the case where an aqueous solution containing the wax of 0.1 weight % is prepared, the wax has a property which enables any one of the following relationships (A) to (D) to be satisfied, (A) the solution has a transmittance of at least 50% and less than 100% with respect to light having a wavelength of 450 nm, (B) the solution has a transmittance of at least 60% and less than 100% with respect to light having a wavelength of 550 nm, (C) the solution has a transmittance of at least 70% and less than 100% with respect to light having a wavelength of 650 nm, and (D) the solution has a transmittance of at least 70% and less than 100% with respect to light having a wavelength of 750 nm.

In the first aspect of the invention, the ink composition having the following advantages is provided. In the case where the ink composition is formed into a coating, glossiness imparted by the glitter pigment is not decreased. The ink composition can be therefore used to form an image having excellent glossiness and excellent abrasion resistance.

In the ink composition according to the first aspect of the invention, it is preferable that the wax is contained in an amount that is in the range from 0.02 to 1.5 weight %.

In such an ink composition, the wax content from 0.02 to 1.5 weight % contributes to enhancing the transparency of the wax as an additive. The ink composition having the following advantages is therefore provided. In the case where the ink composition is formed into a coating, glossiness imparted by the glitter pigment is not decreased. The ink composition can be accordingly used to form an image having excellent glossiness and excellent abrasion resistance.

In the ink composition according to the first aspect of the invention, assuming that the silver content is X_{Ag} (weight %) and that the wax content is X_{WAX} (weight %), it is preferable that the relationship of 0.0015≦X_{WAX}/X_{Ag}≦0.1 is satisfied.

In such an ink composition, assuming that the silver content is X_{Ag} (weight %) and that the wax content is X_{WAX} (weight %), the relationship of 0.0015≦X_{WAX}/X_{Ag}≦0.1 is satisfied, thereby being able to impart further excellent luster (high-quality finish) and abrasion resistance to an image formed by using the ink composition. In addition, the ink composition can be ejected by an ink jet technique with especially excellent stability (accuracy of landing position and stability in ejection amount), and images having intended quality can be further steadily formed for a long period.

In the ink composition according to the first aspect of the invention, it is preferable that the glitter pigment has an average particle size that is in the range from 1 to 100 nm.

In such an ink composition, the glitter pigment has an average particle size that is in the range from 1 to 100 nm, thereby being able to impart further excellent luster (high-quality finish) and abrasion resistance to an image formed by using the ink composition. In addition, the ink composition can be ejected by an ink jet technique with especially excellent stability (accuracy of landing position and stability in ejection amount), and images having intended quality can be further steadily formed for a long period.

In the ink composition according to the first aspect of the invention, it is preferable that the wax includes paraffin-mixed wax, polyethylene wax, and polyethylene-mixed wax.

In such an ink composition, the wax includes the paraffin-mixed wax, polyethylene wax, and polyethylene-mixed wax, thereby being able to impart further excellent luster (high-quality finish) and abrasion resistance to an image formed by using the ink composition. In addition, the ink composition can be ejected by an ink jet technique with especially excellent stability (accuracy of landing position and stability in ejection amount), and images having intended quality can be further steadily formed for a long period.

In the ink composition according to the first aspect of the invention, in the case where an aqueous solution containing the wax of 0.1 weight % is prepared, it is preferable that the wax has a property which enables any one of the following relationships (E) to (H) to be satisfied, (E) the solution has a transmittance from 75 to 85% with respect to light having a wavelength of 450 nm, (F) the solution has a transmittance from 80 to 90% with respect to light having a wavelength of 550 nm, (G) the solution has a transmittance from 85 to 94% with respect to light having a wavelength of 650 nm, and (H) the solution has a transmittance from 85 to 96% with respect to light having a wavelength of 750 nm.

Such an ink composition has the following advantages. In the case where the ink composition is formed into a coating, glossiness imparted by the glitter pigment is not decreased. The ink composition can be therefore used to form an image having excellent glossiness and excellent abrasion resistance.

In the ink composition according to the first aspect of the invention, it is preferable that the wax has a melting point that is in the range from 30 to 120° C.

By virtue of such an ink composition, an image having excellent glossiness and excellent abrasion resistance can be formed.

According to a second aspect of the invention, a printed article is provided, which is formed as a result of applying the ink composition having any of the above advantages onto a recording medium by an ink jet technique.

In the second aspect of the invention, a printed article in which an image having excellent glossiness and excellent abrasion resistance is formed can be provided.

### BRIEF DESCRIPTION OF THE DRAWINGS

The invention will be described with reference to the accompanying drawings, wherein like numbers reference like elements.

FIGURE is a perspective view schematically illustrating the configuration of an ink jet apparatus.

### DESCRIPTION OF EXEMPLARY EMBODIMENTS

Preferred embodiments of the invention will be described in detail.

### Ink Composition

The ink composition of embodiments of the invention is ejected by an ink jet technique. Unlike ink compositions which are used in other printing techniques, droplets of the ink composition need to be ejected with sufficient stability. In the ink jet technique, the dispersion state of a material (dispersed material) which is dispersed in the ink composition has a large influence on the ejection properties of the ink composition.

In the case where the dispersion state of the material (dispersed material) which is dispersed in the ink composition is significantly changed with time, problems which are not caused in other printing techniques may be therefore caused. In particular, the ink droplets may be ejected in an unstable amount with the result that intended images are less likely to be formed.

In the case where an aqueous solution containing the wax of 0.1 weight % is prepared, the wax has a property which enables any one of the following relationships (A) to (D) to be satisfied, (A) the solution has a transmittance of at least 50% and less than 100% with respect to light having a wavelength of 450 nm, (B) the solution has a transmittance of at least 60% and less than 100% with respect to light having a wavelength of 550 nm, (C) the solution has a transmittance of at least 70% and less than 100% with respect to light having a wavelength of 650 nm, and (D) the solution has a transmittance of at least 70% and less than 100% with respect to light having a wavelength of 750 nm.

The inventors have found the following: the wax serves to form predetermined relationship to the glitter pigment in transmittance and is contained in the ink composition together with the glitter pigment in a predetermined amount, thereby being able to form an image with good glossiness and abrasion resistance by using the ink composition.

### Glitter Pigment

As described above, the ink composition of embodiments of the invention contain the glitter pigment. The ink composition contains the glitter pigment (in particular, together with wax contained such that a predetermined relationship is satisfied), thereby being able to form an image having excellent glossiness. Although any glitter pigment which is applied onto a medium and then provides glossiness may be used, examples of such a glitter pigment include an alloy formed by using one or more materials selected from the group consisting of aluminum, silver, gold, platinum, nickel, chromium, tin, zinc, indium, titanium, and copper and include a pearl pigment having pearl luster.

In embodiments of the invention, silver or aluminum is preferably employed as the glitter pigment. Among various metals, because silver and aluminum exhibit high whiteness, the silver and aluminum are used in combination with inks of the other colors, thereby producing various metallic colors such as gold and bronze.

Although the glitter pigment may have an average particle size which enables a predetermined relationship to the wax to be satisfied, the glitter pigment has an average particle size that is preferably in the range from 1 to 100 nm, more preferably in the range from 3 to 80 nm. Within such ranges, further excellent luster (high-quality finish) and abrasion resistance can be imparted to an image formed by using the ink composition. In addition, the ink composition can be ejected by an ink jet technique with especially excellent stability (accuracy of landing position and stability in ejection amount), and images having intended quality can be further steadily formed for a long period.

The term “average particle size” as used herein refers to a volume-based average particle size unless otherwise noted. The average particle size can be measured with a particle size distribution analyzer based on a laser diffraction-scattering technique. Examples of a particle size distribution analyzer utilizing the laser diffraction include a particle size distribution analyzer based on dynamic light scattering (for example, “Microtrac UPA” commercially available from NIKKISO CO., LTD.).

Silver particles will be hereinafter described as an appropriate example of the glitter pigment of a preferred embodiment. The silver particles are contained in the ink composition in an amount that is preferably in the range from 0.5 to 30 weight %, more preferably in the range from 5.0 to 15 weight %. Within such ranges, the ink composition can be ejected by an ink jet technique with especially excellent stability and can be preserved with especially excellent stability. Furthermore, in the case where a printing medium has been used to produce a printed article, excellent image quality and abrasion resistance can be provided even if a density range (content per unit area) of the silver particles on the printing medium broadly varies from a high level to a low level. Even if the printed article which has been produced by using the ink composition has regions individually having different silver particle densities, for example, the image quality of the printed article can be therefore enhanced.

The silver particles may be prepared through any process. For example, a solution containing silver ions is prepared, and the silver ions are then reduced, thereby being able to desirably produce the silver particles.

### Wax

The ink composition contains the wax. Although the amount of the wax contained in the ink composition is not specifically limited, the ink composition preferably contains the wax in an amount that is in the range from 0.02 to 1.5 weight % as described above. In the case where the amount of the wax falls below the lower limit of such a range, excellent abrasion resistance may not be sufficiently imparted to the printed article produced by using the ink composition. In contrast, in the case where the amount of the wax exceeds the upper limit of such a range, excellent luster may not be sufficiently imparted to the printed article produced by using the ink composition.

Although the amount of the wax contained in the ink composition of embodiments of the invention is not specifically limited, the wax is contained in an amount that is preferably in the range from 0.02 to 1.5 weight %, more preferably in the range from 0.04 to 1.0 weight %, and further preferably in the range from 0.05 to 0.5 weight %. Within such ranges, the above advantageous effects can be further sufficiently provided.

As described above, in the case where the wax to be contained in the ink composition is used to prepare a solution of the wax of 0.1 weight % (water content of 99.9 weight %), the wax enables the solution to exhibit transmittance as follows: the solution has a transmittance of at least 50% and less than 100% with respect to light having a wavelength of 450 nm; the solution has a transmittance of at least 60% and less than 100% with respect to light having a wavelength of 550 nm; the solution has a transmittance of at least 70% and less than 100% with respect to light having a wavelength of 650 nm; or the solution has a transmittance of at least 70% and less than 100% with respect to light having a wavelength of 750 nm. Transmittance is preferably exhibited as follows: the solution has a transmittance of at least 65% and less than 100% with respect to light having a wavelength of 450 nm; the solution has a transmittance of at least 80% and less than 100% with respect to light having a wavelength of 550 nm; the solution has a transmittance of at least 85% and less than 100% with respect to light having a wavelength of 650 nm; or the solution has a transmittance of at least 85% and less than 100% with respect to light having a wavelength of 750 nm. Furthermore, transmittance is more preferably exhibited as follows: the solution has a transmittance from 75 to 85% with respect to light having a wavelength of 450 nm; the solution has a transmittance from 80 to 90% with respect to light having a wavelength of 550 nm; the solution has a transmittance from 85 to 94% with respect to light having a wavelength of 650 nm; or the solution has a transmittance from 85 to 96% with respect to light having a wavelength of 750 nm. In other words, in the case where a solution which contains the wax of 0.1 weight % is prepared, the wax preferably has a property which enables any one of the following relationships (E) to (H) to be satisfied, (E) the solution has a transmittance from 75 to 85% with respect to light having a wavelength of 450 nm, (F) the solution has a transmittance from 80 to 90% with respect to light having a wavelength of 550 nm, (G) the solution has a transmittance from 85 to 94% with respect to light having a wavelength of 650 nm, and (H) the solution has a transmittance from 85 to 96% with respect to light having a wavelength of 750 nm. In each of the wavelengths, in the case where the transmittance falls below the lower limit of the above range, because the wax as a dispersing element has low transparency, a printed article produced by using the ink composition enters a state in which the glitter pigment is covered with the wax having low transparency, thereby causing a problem in which the glossiness of the printed article is reduced.

The wax contained in the ink composition preferably has an average particle size that is in the range from 8 to 120 nm, more preferably in the range from 20 to 100 nm, and further preferably in the range from 50 to 90 nm. Within such ranges, the above advantageous effects can be further sufficiently provided.

The wax has a melting point that is preferably in the range from 30 to 120° C., more preferably in the range from 30 to 100° C. Within such ranges, further enhanced advantageous effect can be provided.

Assuming that the glitter pigment content is X_{Ag} (weight %) and that the wax content is X_{WAX} (weight %), the relationship of preferably 0.0015≦X_{WAX}/X_{gp}≦0.1 is satisfied, more preferably 0.001≦X_{WAX}/X_{gp}≦0.1, further preferably 0.006≦X_{WAX}/X_{gp}≦0.1, and most preferably 0.01≦X_{WAX}/X_{gp}≦0.1. Owing to satisfying such relationship, images can be formed by using the ink composition so as to sufficiently have excellent luster (high-quality finish). Furthermore, in the printed article produced by using the ink composition, the wax can be further sufficiently positioned between the glitter pigment, and the printed article can be therefore produced so as to have especially excellent abrasion resistance.

Examples of the wax include resin wax such as paraffin wax, paraffin-mixed wax, polyethylene, oxidized high-density polyethylene wax, polyethylene wax, polyethylene-mixed wax, polypropylene wax, polypropylene-mixed wax, carnauba wax, and amide wax, and these types of resin wax can be used alone or in combination of two or more. Because paraffin wax exhibits poor miscibility with water, paraffin-mixed wax which is prepared so as to have enhanced miscibility is preferably employed. Alternatively, polyethylene wax and polyethylene-mixed wax are preferably employed.

By virtue of using such wax, especially excellent luster (glossiness) and abrasion resistance can be imparted to an image formed by using the ink composition. In addition, the ink composition can be ejected by an ink jet technique with especially excellent stability (accuracy of landing position and stability in ejection amount), and images having intended quality can be further steadily formed for a long period.

Examples of a commercially available wax-dispersed liquid (emulsion wax) include AQUACERs 507, 515, 531, 537, and 539; and CERAFLOURs 990 and 995 (each being produced by BYK Japan KK).

### Water

The ink composition of embodiments of the invention may contain water in an amount of 50 weight % or larger, namely, may be provided in the form of an aqueous ink. As compared with a non-aqueous (solvent-based) ink, the aqueous ink exhibits weak reactivity with, for example, a piezoelectric device used in a recording head and an organic binder contained in a recording medium, and problems in which the piezoelectric device and organic binder are solved and corroded are therefore reduced. Furthermore, in the case of using a non-aqueous (solvent-based) ink which contains a solvent having a high boiling point and low viscosity, a problem is caused, in which significantly long time is taken for drying the ink. Moreover, an aqueous ink is significantly less odorous as compared with the solvent-based ink, and because water content accounts for more than half of the component content of the aqueous ink, the aqueous ink has an advantage of being environmentally friendly. Examples of the water include ion-exchanged water, reverse osmosis water, distilled water, and ultrapure water.

In the ink composition, the water serves as a dispersion medium in which the silver particles and wax are mainly dispersed. The water is contained in the ink composition, so that the silver particles and the likes can be dispersed with excellent stability. In addition, unwanted drying of the ink composition (evaporation of dispersion medium) can be prevented in the vicinity of the nozzles of a droplet ejection apparatus which will be hereinafter described, and the ink composition which has been applied onto a recording medium can be promptly dried. Intended images can be therefore desirably printed at high speed for a long period.

### Polyhydric Alcohol

The ink composition of embodiments of the invention preferably contains polyhydric alcohol. In the case where the ink composition of embodiments of the invention is applied to an ink jet printing apparatus, the polyhydric alcohol serves to prevent the ink composition from being dried, and the occurrence of clogging due to the dried ink composition is therefore prevented in the print head of the ink jet printing apparatus.

Examples of the polyhydric alcohol include ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, trimethylolpropane, 1,2-butanediol, 1,2-pentanediol, 1,2-hexanediol, 1,2-heptanediol, and 1,2-octanediol. Among these, alkanediol having four to eight carbon atoms is preferably employed, and alkanediol having six to eight carbon atoms is more preferably employed. Such polyhydric alcohol enables the permeability of the ink composition to a recording medium to be especially enhanced.

Although the amount of the polyhydric alcohol contained in the ink composition is not specifically limited, the polyhydric alcohol is contained in an amount that is preferably in the range from 1 to 50 weight %, more preferably in the range from 3 to 40 weight %.

### Penetrating Solvent

The ink composition of embodiments of the invention preferably contains a penetrating solvent. The use of the penetrating agent enables wettability for the printing surface of a printing medium to be enhanced, thereby being able to improve the permeability of the ink composition.

Examples of the penetrating solvent include lower alkyl ethers of polyhydric alcohols, such as glycol ethers including ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether; and aqueous solvents such as 1,2-hexanediol, octanediol, and 2-pyrrolidon. Among these, 1,2-hexanediol is used, thereby being able to provide good printing quality.

Although the amount of the penetrating agent contained in the ink composition is not specifically limited, the penetrating agent is contained in an amount that is preferably in the range from 0.1 to 10 weight %, more preferably in the range from 0.3 weight % to 7 weight %.

### Surfactant

Although a surfactant is not necessarily contained in the ink composition of embodiments of the invention, an acetylene glycol-based surfactant or a polysiloxane-based surfactant is preferably contained. Use of the acetylene glycol-based or polysiloxane-based surfactant can serve to enhance the wettability for the printing surface of a recording medium, thereby improving the permeability of the ink composition.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, and examples of such a commercially available product include OLFINEs E1010, STG, and Y (each being produced by Nissin Chemical Industry Co., Ltd.); and SURFYNOLs 104, 82, 465, 485, and TG (each being produced by Air Products and Chemicals, Inc.).

A commercially available product may be used as the polysiloxane-based surfactant, and examples of such a commercially available product include BYK-347, BYK-348, and AQUACER 593 (produced by BYK Japan KK).

The ink composition of embodiments of the invention may contain other surfactants including anionic surfactants such as polyoxyethylene alkyl ether, nonionic surfactants, and amphoteric surfactants.

Although the amount of the surfactant contained in the ink composition is not specifically limited, the surfactant is contained in an amount that is preferably in the range from 0.01 to 5.0 weight %, more preferably in the range from 0.1 to 3 weight %.

### Other Components

The ink composition of embodiments of the invention may contain components other than the above components (other components). Examples of such other components include a pH adjuster, penetrant, organic binder, urea compound, drying inhibitor such as alkanolamine (triethanolamine or the like), and thiourea.

In the case where the ink composition contains solids other than the silver particles (glitter pigment) and wax (hereinafter referred to as “other solids”, where appropriate), the ink composition contains other solids in an amount of preferably 5 weight % or lower, more preferably 1 weight % or lower. Within such ranges, the effect which is provided by the silver particles and wax that are contained so as to satisfy the above relationship can be further sufficiently provided.

The ink composition contains the solids in an amount of preferably 50 weight % or lower, more preferably in the range from 3.6 to 40 weight %, and further preferably in the range from 5 to 20 weight %. Within such ranges, the ink composition can be ejected with especially excellent stability.

Although the viscosity of the ink composition is not specifically limited, the ink composition has a viscosity that is preferably in the range from 2.0 to 12.0 mPa·s, more preferably in the range from 3.0 to 5.0 mPa·s. Within such ranges, droplets of the ink composition can be ejected with excellent stability, unwanted spread of the ink composition which has landed on a recording medium can be further steadily prevented, and even images having fine structures can be desirably formed. The term “viscosity” as used herein refers to a viscosity which is measured by using a vibro-viscometer at a temperature of 25° C. in accordance with JIS 28809, unless otherwise noted.

### Printed Article

The printed article of embodiments of the invention can be produced as a result of applying the above ink composition onto a recording medium by an ink jet technique. The printed article in which an image having excellent glossiness and abrasion resistance is formed can be therefore provided.

Examples of the printing medium onto which the ink composition is applied include sheets such as plain paper and specialty paper having an ink-receiving layer and include a substrate having a region including a surface onto which the ink composition is applied, the region being made from various types of plastic, ceramic, glass, and metallic materials or a composite material thereof.

### Method for Producing Printed Article

FIGURE is a perspective view schematically illustrating the configuration of an ink jet recording apparatus (droplet ejection apparatus).

A method for producing the printed article of embodiments of the invention include a process for ejecting the above ink composition onto a recording medium with an ink jet recording apparatus (droplet ejection apparatus) illustrated in FIGURE (droplet ejection process).

### Droplet Ejection Process

Droplet ejection using an ink jet printer 1 as the droplet ejection apparatus will be hereinafter described.

With reference to FIGURE, the ink jet printer 1 as the droplet ejection apparatus has a frame 2. A platen 3 is provided to the frame 2, and a paper feed motor 4 is driven to transport paper P onto the platen 3. A rod-like guide member 5 is provided to the frame 2 in parallel with the longer direction of the platen 3.

A carriage 6 is supported by the guide member 5 so as to be able to reciprocate in the axial direction of the guide member 5. The carriage 6 is connected to a carriage motor 8 through a timing belt 7 which is provided to the inside of the frame 2. The carriage motor 8 can be driven, thereby reciprocating the carriage 6 in parallel with the guide member 5.

The carriage 6 has a droplet ejection head 9, and an ink cartridge 10 is removably attached to the carriage 6, the ink cartridge 10 serving to supply ink as liquid to the droplet ejection head 9. The ink inside the ink cartridge 10 is supplied to the droplet ejection head 9 as a result of driving of a piezoelectric device (not illustrated) provided to the droplet ejection head 9. The ink is then ejected from a plurality of nozzles onto the printing medium (substrate) P transported onto the platen 3, the nozzles being formed on the nozzle-formed surface of the droplet ejection head 9.

In this manner, the printed article can be produced.

### Heating Process

In the method for producing the printed article, a heating process may be provided in addition to the droplet ejection process, thereby heating the printing medium onto which the ink composition has been applied.

Because the ink composition of embodiments of the invention contains water as a dispersion medium as described above, the ejected ink composition is immediately dried, and an additional drying process does not generally need to be provided after the ejection process. However, even if the printing medium P has a high water-holding property and the ink composition contains a low-volatile liquid component in a relatively high amount (for example, a case in which a liquid component having a boiling point of 160° C. or higher is contained in an amount of 3 weight % or larger), the heating process effectively enables the liquid component contained in the ink composition to be prevented from remaining in the produced printed article. In addition, the printed article can be produced so as to have especially excellent durability and reliability.

Furthermore, by virtue of the heating process, in a state in which the wax is positioned between the silver particles, partial fusion of the silver particles can be facilitated. Such partial fusion therefore synergistically acts together with the effect provided by the wax that is contained so as to satisfy the above specific relationship, and images (printed articles) can be formed by using the ink composition so as to have especially excellent abrasion resistance.

Although the preferred embodiments of the invention have been described above, embodiments of the invention are not limited to the above embodiments. Although a case in which a colloidal liquid is used as the ink composition has been representatively described in the above embodiments, for example, the colloidal liquid may not be used.

Furthermore, although the piezoelectric technique is employed as the droplet ejection technique in the above embodiments, the droplet ejection technique is not limited to such a technique. In embodiments of the invention, for example, various known techniques can be employed, such as a technique in which ink is ejected by utilizing bubbles generated as a result of heating the ink.

Moreover, although the ink composition is ejected by the ink jet technique in the above embodiments, the ink composition may be applied to other printing techniques.

### EXAMPLES

Examples of embodiments of the invention will be specifically described.

### 1. Preparation of Ink Composition

### Example 1

Polyvinylpyrrolidone (PVP, weight-average molecular weight: 10000) was heated at a temperature of 70° C. for 15 hours and was then cooled at room temperature. The PVP of 1000 g was then added to an ethylene glycol solution of 500 ml, thereby preparing a PVP solution. Ethylene glycol of 500 ml was put into another container, and silver nitrate of 128 g was then added. The resultant product was then sufficiently stirred with an electromagnetic stirrer, thereby preparing a silver nitrate solution. The silver nitrate solution was added to the PVP solution while the PVP solution was stirred with an overhead mixer at a temperature of 120° C. The resultant product was heated for approximately 80 minutes, thereby promoting a reaction. The resultant product was then cooled at room temperature. The produced solution was subjected to centrifugal separation with a centrifugal separator at a rate of 2200 rpm for 10 minutes. The separated silver particles were subsequently retrieved and were then added to an ethanol solution of 500 ml to remove excessive PVP. The resultant product was further subjected to the centrifugal separation, and the separated silver particles were then retrieved. The retrieved silver particles were subsequently dried with a vacuum drier at a temperature of 35° C. under a pressure of 1.3 Pa.

The produced silver particles were added to pure water, and the resultant product was stirred for three hours, thereby dispersing the silver particles. In this manner, a dispersion liquid containing 20% solid contents was prepared, thereby producing a silver-dispersing aqueous liquid.

The silver particles produced as described above were mixed with 1,2-hexanediol, trimethylolpropane, OLFINE E1010 (commercially available from Nissin Chemical Industry Co., Ltd.) as a surfactant, AQUACER 539 (commercially available from BYK Japan KK) as wax (paraffin-mixed wax), and ion exchanged water in accordance with the composition listed in Table 2, thereby preparing an ink composition.

In this example, the average particle size of the silver particles was measured with Microtrac UPA (commercially available from NIKKISO CO., LTD.), and measurement conditions were employed as follows: a refractive index was 0.2 to 3.9 i; the refractive index of a solvent (water) was 1.333; and the particles to be measured had spherical shapes. Meanwhile, the following types of wax were employed as listed in Tables 1 and 2: AQUACER 539 (commercially available from BYK Japan KK, melting point of 90° C.) as wax (paraffin-mixed wax); AQUACER 537 (commercially available from BYK Japan KK, melting point of 110° C.) as wax (paraffin-mixed wax); AQUACER 507 (commercially available from BYK Japan KK, melting point of 130° C.) as wax (polyethylene-based mixed wax); AQUACER 531 (commercially available from BYK Japan KK, melting point of 130° C.) as wax (polyethylene wax); and SELOSOL H-620 (commercially available from CHUKYO YUSHI CO., LTD., melting point of 68° C.) as wax (paraffin wax).

### Examples 2 to 5

The types and amounts of components to be used for preparing the ink compositions were adjusted, thereby providing composition listed in Table 2. Except these, ink compositions were individually prepared in the same manner as employed in the example 1.

### Comparison Examples 1 to 5

The types and amounts of components to be used for preparing the ink compositions were adjusted, thereby providing composition listed in Table 2. Except these, ink compositions were individually prepared in the same manner as employed in the example 1.

In Table 2, the composition of the ink compositions of the examples and comparison examples are listed. Furthermore, in each of the examples, the ink composition had a viscosity that was in the range from 3.0 to 5.0 mPa·s (viscosity measured with a vibro-viscometer at a temperature of 25° C. in accordance with JIS Z8809).

### 2. Measurement of Transmittance of Aqueous Solution Containing 0.1 weight % Wax

The transmittance (% T) of an aqueous solution (99.9 weight % water) containing 0.1 weight % wax produced in each of the examples was measured as follows by using a spectrophotometer U3300 commercially available from Hitachi, Ltd.

Two quartz cells each having a length of 1 cm, width of 1 cm, and a height of 4 cm and having a volume of 4 ml were prepared, and these cells were individually used as a sample cell and a reference cell. Pure water was put into both cells, and baselines were determined in the cells. The reference cell was allowed to stand, and the pure water in the sample cell was replaced with an aqueous solution which had been prepared by using pure water so as to contain the 0.1 weight% wax. The sample was prepared as follows: the wax of each of the examples was put into a 1 L beaker in an amount of 1.00 g; and pure water was then immediately put into the beaker until the wax and pure water had a total weight of 1 kg.

The sample cell and reference cell were each subsequently set in a measuring section of the spectrometer, and the transparence (% T) was measured under the following conditions: 2.0 nm in the slit width of a light source lamp; a scan rate of 600 nm/min in a measurement interval; transmittance in the range from 0.0 to 100.0 % T; wavelength in the range from 380 to 800 nm; D65 light source; view angle of 2°; photomultiplier voltage of 200 V; and light source changed from a D2 lamp to a WI lamp at a wavelength of 340 nm. The resultant transmittance (% T) of each of the solutions containing 0.1 weight % wax is listed in Table 1.

TABLE 1

| | | Transmittance of 0.1 weight % | | | |
|---|---|---|---|---|---|
| | | aqueous solution (% T) | | | |
| | | 450 | 550 | 650 | 750 |
| Wax type | Composition | nm | nm | nm | nm |
| AQUACER 539 | Paraffin-mixed wax | 73% | 86% | 92% | 95% |
| AQUACER 537 | Paraffin-mixed wax | 86% | 93% | 96% | 97% |
| AQUACER 507 | Polyethylene-mixed | 88% | 94% | 97% | 98% |
| | wax | | | | |
| AQUACER 531 | Polyethylene wax | 5% | 21% | 40% | 58% |
| SELOSOL H-620 | Paraffin wax | 1% | 1% | 1% | 1% |

### 3. Production of Printed Article

Printed articles were individually produced as follows by using the ink compositions of the examples and comparison examples.

Ink jet specialty paper (photo paper) [glitter photo paper (commercially available from SEIKO EPSON CORPORATION)] was prepared as a printing medium.

The droplet ejection apparatus illustrated in FIGURE was used to apply the ink composition onto a surface of the printing medium such that a certain pattern was formed at 40% duty, the surface having an ink-receiving layer. The printed article was produced in this manner. Meanwhile, the term “duty” as used herein refers to values obtained from the following formula.

duty (%)=number of actually printed dots/(longitudinal resolution×lateral resolution)×100 (in the formula, the term “number of actually printed dots” refers to the number of actually printed dots per unit area, and the terms “longitudinal resolution” and “lateral resolution” each refer to resolution per unit area).

### 4. Evaluation

### 4. 1. Gloss

A gloss meter (MINOLTA MULTI GLOSS 268) was used to measure the gloss of the printing surfaces of the printed articles at a tilt angle of 60°, the printed articles being individually produced by using the ink compositions of the examples and comparison examples. The measurement results were then evaluated on the basis of the following criteria.

A: gloss was 500 or larger,
B: gloss was 450 or larger and less than 500,
C: gloss was 400 or larger and less than 450,
D: gloss was 350 or larger and less than 400,
E: gloss was 300 or larger and less than 350,
F: gloss was 250 or larger and less than 300, and
G: gloss was less than 250.

### 4. 2. Abrasion Resistance

A Sutherland Rub Tester was used to analyze the abrasion resistance of the printed articles in accordance with JIS K5701 after the passage of 48 hours from the production thereof, the printed articles being individually produced by using the ink compositions of the examples and comparison examples. After the abrasion resistance analysis, the gloss (tilt angle of) 60° of the printed articles was also measured in the same manner as described in the part titled “4. 1. Gloss”. The decreasing rate of the gloss before the abrasion resistance analysis to the gloss after the abrasion resistance analysis was obtained, and the results were then evaluated on the basis of the following criteria.

A: the decreasing rate of gloss was less than 10%,
B: the decreasing rate of gloss was 10% or larger and less than 15%,
C: the decreasing rate of gloss was 15% or larger and less than 20%,
D: the decreasing rate of gloss was 20% or larger and less than 25%,
E: the decreasing rate of gloss was 25% or larger and less than 30%,
F: the decreasing rate of gloss was 30% or larger and less than 35%, and
G: the decreasing rate of gloss was 35% or larger and less than 50%.

Measurement results are listed in Table 2.

TABLE 2

| | | | | | | Comparison | Comparison | Comparison | Comparison | Comparison |
|---|---|---|---|---|---|---|---|---|---|---|
| | Example 1 | Example 2 | Example 3 | Example 4 | Example 5 | example 1 | example 2 | example 3 | example 4 | example 5 |
| 1,2-hexanediol | 3 | 3 | 3 | 3 | 3 | 3 | 3 | 3 | 3 | 3 |
| Moisturizing | 10 | 10 | 10 | 10 | 10 | 10 | 10 | 10 | 10 | 10 |
| agent (TMP) | | | | | | | | | | |
| Water | balance | balance | balance | balance | balance | balance | balance | balance | balance | balance |
| Surfactant | 1 | 1 | 1 | 1 | 1 | 1 | 1 | 1 | 1 | 1 |
| Silver dispersion | 10 | 10 | 10 | 10 | 10 | 10 | 10 | 10 | 10 | 10 |
| (solid content) | | | | | | | | | | |
| AQ539 | 0.02 | 0.1 | 1 | | | | | 0.01 | 1.1 | |
| AQ537 | | | | 0.1 | | | | | | |
| AQ507 | | | | | 0.1 | | | | | |
| AQ531 | | | | | | 0.1 | | | | |
| SELOSOL H-620 | | | | | | | 0.1 | | | |
| Transmittance in | 96% | 96% | 96% | 98% | 98% | 58% | 3% | 96% | 96% | — |
| 0.1 weight % wax | | | | | | | | | | |
| Gloss Evaluation | A | A | C | A | B | D | D | A | D | A |
| Abrasion | C | A | A | B | B | B | B | D | A | E |
| resistance | | | | | | | | | | |

As is obvious from Table 2, although the printed articles of the examples of embodiments of the invention had excellent gloss and abrasion resistance, the printed articles of the comparison examples had insufficient gloss and abrasion resistance.

What is claimed is:

1. An ink composition comprising:
a glitter pigment; and
wax, wherein
in the case where an aqueous solution containing the wax of 0.1 weight % is prepared, the wax has a property which enables any one of the following relationships (A) to (D) to be satisfied,
(A) the solution has a transmittance of at least 50% and less than 100% with respect to light having a wavelength of 450 nm,
(B) the solution has a transmittance of at least 60% and less than 100% with respect to light having a wavelength of 550 nm,
(C) the solution has a transmittance of at least 70% and less than 100% with respect to light having a wavelength of 650 nm, and
(D) the solution has a transmittance of at least 70% and less than 100% with respect to light having a wavelength of 750 nm.

2. The ink composition according to claim 1, wherein the wax is contained in an amount that is in the range from 0.02 to 1.5 weight %.

3. The ink composition according to claim 1, wherein assuming that the glitter pigment content is X_{gp} (weight %) and that the wax content is X_{WAX} (weight %), the relationship of 0.0015≦X_{WAX}/X_{gp}≦0.1 is satisfied.

4. The ink composition according to claim 1, wherein the glitter pigment has an average particle size that is in the range from 1 to 100 nm.

5. The ink composition according to claim 1, wherein the wax includes paraffin-mixed wax, polyethylene wax, and polyethylene-mixed wax.

6. The ink jet ink composition according to claim 1, wherein in the case where an aqueous solution containing the wax of 0.1 weight % is prepared, the wax has a property which enables any one of the following relationships to be satisfied,
(E) the solution has a transmittance from 75 to 85% with respect to light having a wavelength of 450 nm,
(F) the solution has a transmittance from 80 to 90% with respect to light having a wavelength of 550 nm,
(G) the solution has a transmittance from 85 to 94% with respect to light having a wavelength of 650 nm, and
(H) the solution has a transmittance from 85 to 96% with respect to light having a wavelength of 750 nm.

7. The ink jet ink composition according to claim 1, wherein the wax has a melting point that is in the range from 30 to 120° C.

8. A printed article which is produced as a result of applying the ink composition of claim 1 onto a recording medium by an ink jet technique.

9. A printed article which is produced as a result of applying the ink composition of claim 2 onto a recording medium by an ink jet technique.

10. A printed article which is produced as a result of applying the ink composition of claim 3 onto a recording medium by an ink jet technique.

11. A printed article which is produced as a result of applying the ink composition of claim 4 onto a recording medium by an ink jet technique.

12. A printed article which is produced as a result of applying the ink composition of claim 5 onto a recording medium by an ink jet technique.

13. A printed article which is produced as a result of applying the ink composition of claim 6 onto a recording medium by an ink jet technique.

14. A printed article which is produced as a result of applying the ink composition of claim 7 onto a recording medium by an ink jet technique.
